(19) United States
(12) Patent Application Publication
(10) Pub. No.: US 2016/0255472 A1
(43) Pub. Date: Sep. 1, 2016

(54) Spatial Tracking System

(71) Applicant: GeoSyte, LLC, Glendale, AZ (US)

(72) Inventor: Andrew Wise, Glendale, AZ (US)

(21) Appl. No.: 15/054,041

(22) Filed: Feb. 25, 2016

Related U.S. Application Data
(60) Provisional application No. 62/126,289, filed on Feb. 27, 2015.

(51) Int. Cl. H04W 4/02

(52) U.S. Cl. CPC H04W 4/023

(57) ABSTRACT

A spatial tracking system includes at least two mobile devices, each having wireless communications functionality, a display screen, and a user interface displayed on the display screen; a server in communication with the devices, and programmed to continuously (i) receive position and orientation information from each device, (ii) generate signal information unique to the devices; (iii) calculate distance information and direction information relative to the devices, and (iv) communicate the unique signal information, the distance information and the direction information to the devices. The mobile devices are programmed to continuously (i) receive the unique signal information, the distance information, and the direction information from the server, and (ii) present the received unique signal information, distance information, and direction information on each of the mobile devices. The server and the mobile devices are programmed to continuously perform their respective programmed functions until the mobile devices converge to a common location.

### TECHNICAL FIELD

This disclosure relates to spatial tracking of devices, such as mobile phones and the like.

### BACKGROUND

Often two or more people want to locate each other or locate a common, movable object. For example, when a person calls a vehicle-for-hire service (e.g., a taxi or services like Uber, Lyft, Haxi, or Sidecar) there often can be confusion before the driver and rider locate each other. Another example is a group of people, (e.g., a family) spread out over and moving through a large venue (e.g., an amusement park), who want to find each other. A conventional way for people to find each other in such scenarios involves one calling the other (e.g., on a mobile phone) and telling the other to meet at a fixed location. Oftentimes, however, the fixed location may be sufficiently large, or crowded, that finding each other amongst the crowd is difficult and time-consuming.

### SUMMARY

In an implementation, a spatial tracking system includes at least two mobile devices, each having wireless communications functionality, a display screen, and a user interface displayed on the display screen; a server in communication with the devices, and programmed to continuously (i) receive position and orientation information from each of the devices, (ii) generate signal information unique to the devices; (iii) calculate distance information and direction information relative to the devices, and (iv) communicate the unique signal information, the distance information and the direction information to the devices. The mobile devices are programmed to continuously (i) receive the unique signal information, the distance information, and the direction information from the server, and (ii) present the received unique signal information, distance information, and direction information on each of the mobile devices. The server and the mobile devices are programmed to continuously perform their respective programmed functions until the mobile devices converge to a common location.

In an implementation, a computer-implemented method involves (a) receiving input from a first user device that identifies a second user device; (b) sending a notification to the second user device, the notification notifying a second user associated with the second user device that a first user associated with the first user device desires to converge with the second user at a common location; (c) receiving information from the first user device identifying a location and an orientation of the first user device; (d) receiving information from the second user device identifying a location and an orientation of the second user device; (e) calculating a direction and distance between the first user device and the second user device; (f) generating signal information unique to the first and second user devices; (g) communicating information to the first and second user devices, the communicated information such that the first and second user devices each presents the calculated distance between the user devices, a directional arrow vector pointing one device towards the other, and the unique signal information; and (h) repeating (c), (d), (e), (f), and (g) until the first and second user devices have converged to a common location.

### BRIEF DESCRIPTION OF THE DRAWINGS

FIGS. 1A-1C illustrate a flowchart of an example process for performing techniques described herein.

FIG. 2 illustrates a standard hardware environment in which techniques described herein may be performed.

Like reference numbers and designations in the various drawings indicate like elements.

### DETAILED DESCRIPTION

The present inventor recognized several problem with existing vehicle-for-hire services. For example, ride sharing services, such as Uber, Lyft, Haxi, and Sidecar, along with conventional taxis, often experience difficulties locating their riders when picking them up. The reasons vary from bouncing GPS signals when riders record their initial locations, riders moving from their original location, or the lack of a precise pickup address.

Further, drivers often are approached by many people asking if the ride is for them in crowded pickup areas. Some passengers even enter the car thinking it is their ride when in fact it is already reserved for another passenger. There are many occasions where a driver takes a wrong passenger to their destination, while billing another party's credit card. The most common means of identifying a rider is asking for their first name only, which only exacerbates the problem.

Also, when many drivers appear at a rider's location at the same time (e.g., at a concert venue or other crowded public area), it is difficult for riders to know which driver is theirs. An analogous problem exists with regard to a single car arriving to a location where multiple people have requested rides; each person thinks it is their driver who has arrived. Often vehicle descriptions are given to passengers to identify a driver's vehicle. But the descriptions are often confused or not understood by the passengers.

Riders tend to have analogous problems with locating the drivers, if the driver's car is not in the location they are expecting. The same reasons of bouncing GPS signals when riders record their initial location, riders moving from their original location, or not having a precise pickup address will cause a rider not to find the driver's car. Moreover, riders are susceptible to getting into a car, which might not be a ride share car or taxi at all, causing the person to be put into potential harm.

Drivers trying to spot their respective riders may experience one or more of the following issues: (1) time loss looking for riders; (2) creating excessive traffic while looking for riders (e.g., from driving overly slowly or standing in place and blocking traffic); (3) illegally parking waiting for riders; or (4) making unsafe maneuvers (e.g., cutting across lanes, U-turns) trying to find a rider.

In various implementations, the Spatial Tracking System (“STS”) described here can be used to address problems arising in the vehicle-for-hire services used today. For example, by using STS's real time bidirectional locating system coupled with a positive identification system, drivers and passengers are able to connect faster and safer.

As used herein, a “convergence token” is a semi-permanent interactive information interchange. A “party” is a set of geographically separated spatial points sharing the same convergence token. A party can have two members, e.g., a driver and a rider trying to locate one another, or multiple members, e.g., multiple, related riders in different locations attempting to find the same driver.

The system uses converging geographical spatial points that allow party members to actively seek each other out. The STS uses wireless positioning system/systems, such as GPS, WIFI triangulation, cellular triangulation, and other such wireless positioning systems to identify the respective geographic locations of each party member. STS real time vector indicators (e.g., graphical symbol displayed on a user interface) are used by party members to converge to each other's location. For the visually impaired, vibrations, tones, and/or voice can be used to replace visual vector indicators.

An algorithm calculates the distance between each member of the party, which can be displayed graphically, displayed numerically, sequenced by tones, or spoken orally on each party's device. A driver uses the distance and directional vector to guide them as close as possible to the riders even though the riders may be moving around i.e. walking or running. The riders will be able to walk toward the driver using the distance and directional vector to guide them to the driver. A visual identification signal unique to the party within the same proximity is generated to assist the party in locating each other with nonrepudiation from a distance. An example is a party with flashing yellow mobile phone/tablet/watch screens will know they are paired to each other. Other parties in the same proximity will have a different color scheme such as pink flashing on their mobile phone/tablet/watch screen so there is always a unique sequence hence, there can be no confusion between parties. For visually impaired riders, drivers will be able to see visual impaired riders' mobile phone/tablet/watch screen, and visually impaired riders will feel vibrations, tones, and/or verbal directions of the driver's position.

A close proximity alert is generated within the defined alert distance using visual, vibration and/or audio indicators for a preset time interval. Drivers and riders will be able to compare the unique mobile phone/tablet/watch screen color and flashing sequence from a distance before approaching the vehicle. Visually impaired riders will be able to listen to a confirmation beacon when in close proximity.

The drivers may have an external signaling device either wirelessly connected or wired connected to the mobile phone/tablet/watch device. The external device will be able to generate larger visual or audio signals to increase recognition from a distance. The external device's purpose is to enhance the current system.

Stand-alone devices with mobile wireless capabilities can be used as an alternative to using a mobile phone/tablet/watch device. Such a device would have the ability to generate signals with colors, patterns, vibrations, and/or sounds. The device would have the ability to generate a first signal to pair with a rider. A party member initiates a first signal to other party members with a unique convergence token. A signal may be generated via SMS, email, phone call, internet, or any other wireless transmissions. The party receiving the first signal generates a second signal using the same or different wireless transmission methods, and using the same unique shared token from the first signal. The signals create a private session between the members of the party.

The newly created private session determines the proximity of other parties to assign unique color code, flash sequence, sound, and vibration that will be used within in the same proximity of multiple parties. The proximity areas are geographical boundaries called zones. If another party crosses into a zone which might conflict with signal patterns, the system will auto-generate a new set of signals to the party which left one zone and entered into another party's zone.

When the driver and rider have been paired, the application will stop the bidirectional tracking and identification alerts to protect each other from stalking. A message is displayed and/or spoken on the rider's application that tracking has been canceled plus an advertisement is presented to the rider.

Advertisers can use the rider's pickup location for smart advertising for businesses in the area or national advertisers. The advertisers will be able to target a rider with ads by business establishments or geographic locations where a rider was picked up from and/or is headed to. This system is a web solution requiring no mobile application to be installed on the rider's mobile phone/tablet/watch device or driver's mobile phone/tablet/watch device. However, the functionality of the system may be integrated into existing apps used by ride-share providers and taxis once this application is known. Stand-alone apps may also be created to tap into more of the phone/tablet/watch internal advanced capabilities.

The application can also be used for events, e.g., in which a family has kids in a large amusement park, where parents need to track and find each kid with multiple directional and distance vectors. The kids will have the same ability to locate their parents since they have a directional vector and distance indicator. Kids and parents in close proximity will be able to see each other in large crowds from the flashing phone's colors unique to their party.

A typical process that uses the STS could proceed as follows:

1. The first party member (Driver/Parent/Boss) registers on a website associated with the STS using their personal information (First Name, Last Name, Address, Email, and Mobile Number).

2. The first party member selects the payment terms and pays with a credit card. (Terms: Single Day or Monthly - Recurring or Onetime Payment).

3. The first party member selects the type of vehicle-for-hire service. (Uber, Lyft, Sidecar, Haxi, Taxi, Parent, Boss, etc.).

4. The first party member enters a default notification number or leaves it blank.

5. The first party member is now at the default user screen with the notification number and notification button.

6. The first party member may enter a number or use the default number to send a notification.

7. The first party member clicks the notification button, which causes the system to send an SMS notification to the second party.

8. The mobile device software queries the first party member's mobile device for its GPS location and orientation, then passes it to the web server on a continuous cycle.

9. The second party member (Rider, Kid, Worker) receives a text message with a unique convergence key attached to a hyperlink. No installed mobile application is needed for the second party.

10. The second party member clicks on the hyperlink inside the text message, which directs them to a webpage, which is unique to only them.

11. The first party member's mobile device software queries the second party's mobile device for its GPS location and orientation, then passes it to the web server on a continuous cycle.

12. The web server and/or the first party's mobile device software calculates the distance between the first party member and the second party member with direction vectors on a continuous cycle.

13. The web server generates unique signal information, which includes a flash sequence rate, color, sound, and/or vibration.

14. Each party member's mobile device displays a distance and direction arrow vector relative to the other party member. The first party member's directional arrow vector points to the second party member, and second party member's directional arrow vector points to the first party member.

15. When the parties are within close proximity of each other the signal information is presented to the first and second party member's respective mobile devices.

16. Each party member will use the locations system and signal system to locate each other.

17. When location has been achieved, the system auto terminates GPS location and directional tracking, then displays an ad on the first and/or second party member's respective mobile device.

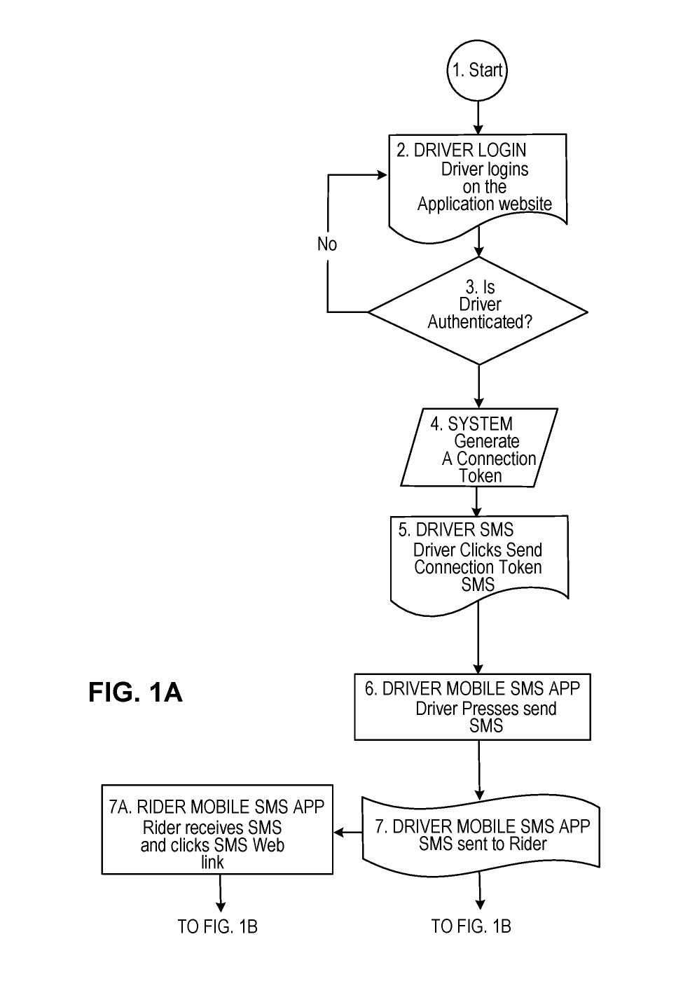

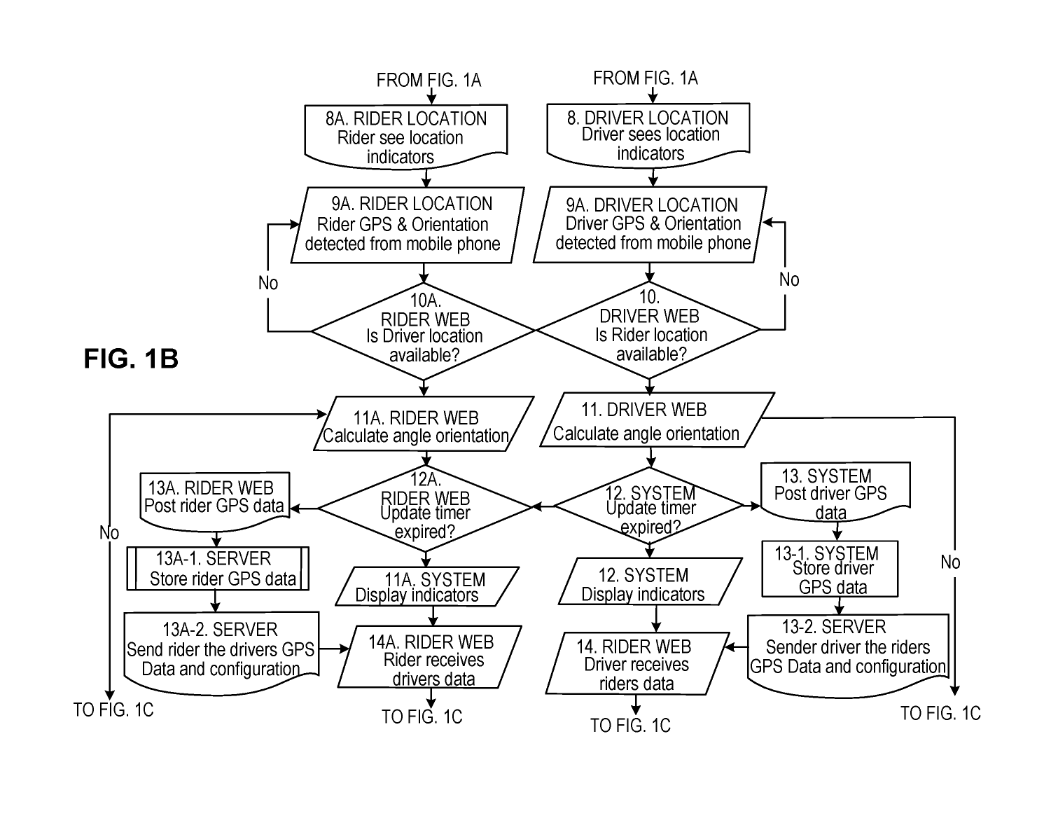

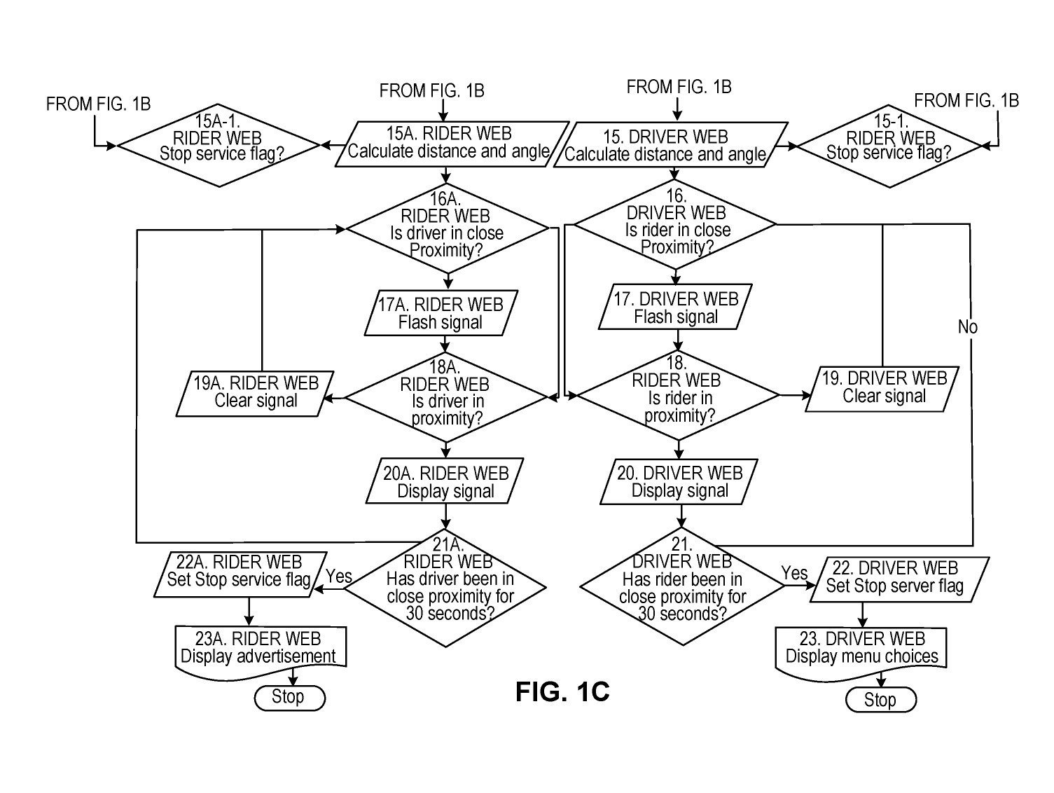

FIGS. 1A-1C illustrate a flowchart of an example process for performing techniques described herein. After starting at step 1, the process next prompts the driver for login credentials at step 2. At step 3, the process determines whether the driver can be authenticated based on the credentials provided. If not, the process returns to step 2 and prompts the driver to try again. If the driver is authenticated at step 3, the process moves to step 4 where the system generates a connection token. A connection token is a unique randomly generated character set. The connection token is used to pass to the rider so the rider is connected only to the person with the connection token. At step 5, the process prompts the driver to contact rider with the default number entered during registration, or allows the driver to modify the default number to another rider's number. Upon pressing the contact rider button, the process continues to step 6, which opens the mobile SMS application. The SMS application will be auto completed with the rider's number and a predetermined message with a connection link including the connection token. The driver sends the SMS message. Step 7 sends the SMS to the mobile carrier for delivery to the rider's SMS mobile device. Step 7A, the process next causes the rider's phone to generate an SMS alert notification. The rider opens the SMS message and clicks on the link embedded in the message.

At steps 8 and 8A, the driver and rider are presented with location arrows with distance indicators. At steps 9 and 9A, the phones GPS and Orientation are detected from drivers and riders mobile device. At steps 10 and 10A, the process determines if the driver location was found for the rider and if the rider's location was found for the driver. If the location was not found, then process returns back to steps 9 and 9A respectively, otherwise it will continues to the next step.

At steps 11 and 11A, the process calculates the vector angle to point the driver's arrow at the rider's location and points the rider's arrow at the driver location. The system then displays those arrows on the driver's and rider's phones. At steps 12 and 12A, the process determines if the direction indicator needs to be updated. If the timer has not expired then the direction is displayed with current coordinates displayed. Otherwise, the position coordinates will be updated. At steps 13 and 13A, the process queries the drivers and riders current GPS position from the mobile device, which causes steps 13-1 and 13A-1 to store the GPS position of the driver and rider on the server. At steps 13-2 and 13A-2, the process exchanges GPS positions by sending the driver, the new rider's GPS position and by sending the rider, the new driver's GPS position. At steps 14 and 14A, the driver and rider devices receives each other's GPS data. At steps 15 and 15A, the process causes the driver and rider devices to make new calculation on direction and distance by using its current GPS location data and comparing with the updated data it received from other device GPS data.

At steps 15-1 and 15A-1, the process stops the devices from receiving each other's GPS, therefore direction and locations (tracking) stops and identification signals are removed from both parties devices. At steps 16 and 16A, the process make a determination if the parties (driver and rider) are within close enough proximity to start identification signals (flashing colors, sounds, etc). At steps 17 and 17A, the driver and rider have been determined to be within close enough proximity to start identification signals. At steps 18 and 18A, the process rechecks to see if the parties are within close enough proximity again. At steps 19 and 19A, the parties' identification signals are stopped because the proximity is not close enough. At steps 20 and 20A, the driver and rider have been determined to be within close enough proximity to start identification signals. At steps 21 and 21A, the process determines if the parties have been in the same proximity for a predetermined period of time. At steps 22 and 22A, the process stops the devices from receiving each others' GPS, therefore direction and locations (tracking) stops and identification signals are removed from both parties' devices. At step 23, the process returns the driver's screen back to default driver's screen to allow another connection to a new rider or same rider. At step 23A, the rider's screen is display an advertisement and thank you message. After steps 23 and 23A, the process stops.

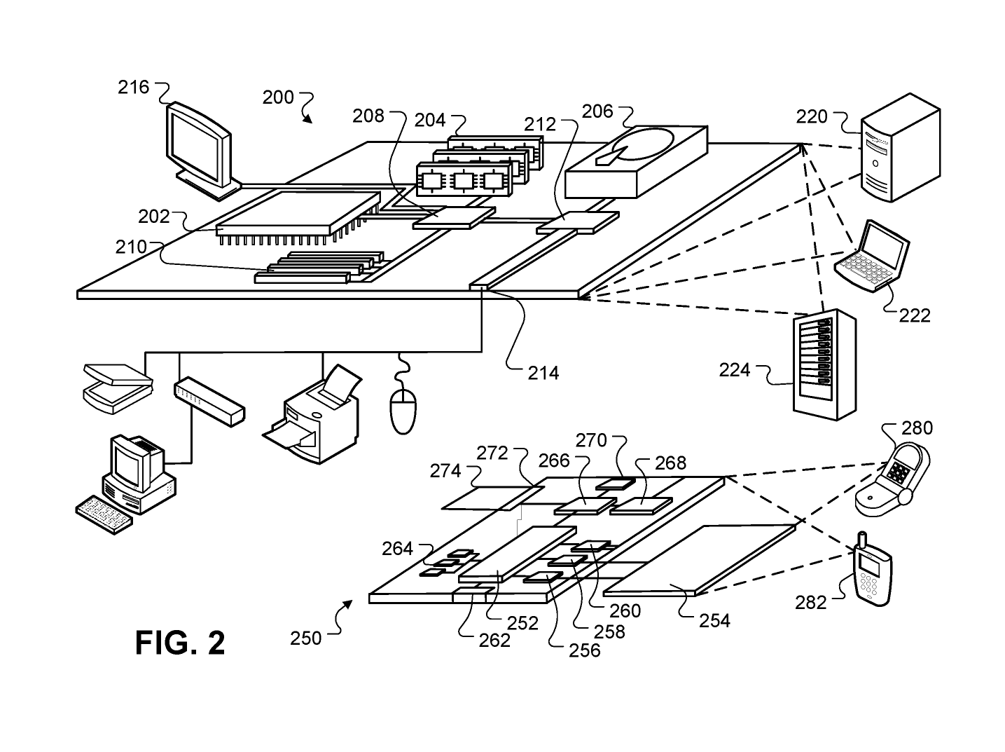

FIG. 2 is a block diagram of computing devices 200, 250 that may be used to implement the systems and methods described in this document, as either a client or as a server or plurality of servers. Computing device 200 is intended to represent various forms of digital computers, such as laptops, desktops, workstations, personal digital assistants, servers, blade servers, mainframes, and other appropriate computers. Computing device 250 is intended to represent various forms of mobile devices, such as personal digital assistants, cellular telephones, smartphones, and other similar computing devices. Additionally computing device 200 or 250 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 200 includes a processor 202, memory 204, a storage device 206, a high-speed interface 208 connecting to memory 204 and high-speed expansion ports 210, and a low speed interface 212 connecting to low speed bus 214 and storage device 206. Each of the components 202, 204, 206, 208, 210, and 212, are interconnected using various busses, and may be mounted on a common motherboard or in other manners as appropriate. The processor 202 can process instructions for execution within the computing device 200, including instructions stored in the memory 204 or on the storage device 206 to display graphical information for a GUI on an external input/output device, such as display 216 coupled to high speed interface 208. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system).

The memory 204 stores information within the computing device 200. In one implementation, the memory 204 is a volatile memory unit or units. In another implementation, the memory 204 is a non-volatile memory unit or units. The memory 204 may also be another form of computer-readable medium, such as a magnetic or optical disk.

The storage device 206 is capable of providing mass storage for the computing device 200. In one implementation, the storage device 206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 204, the storage device 206, or memory on processor 202.

The high speed controller 208 manages bandwidth-intensive operations for the computing device 200, while the low speed controller 212 manages lower bandwidth-intensive operations. Such allocation of functions is exemplary only. In one implementation, the high-speed controller 208 is coupled to memory 204, display 216 (e.g., through a graphics processor or accelerator), and to high-speed expansion ports 210, which may accept various expansion cards (not shown). In the implementation, low-speed controller 212 is coupled to storage device 206 and low-speed expansion port 214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 200 may be implemented in a number of different forms, as shown in the figure. For example, it may be implemented as a standard server 220, or multiple times in a group of such servers. It may also be implemented as part of a rack server system 224. In addition, it may be implemented in a personal computer such as a laptop computer 222. Alternatively, components from computing device 200 may be combined with other components in a mobile device (not shown), such as device 250. Each of such devices may contain one or more of computing device 200, 250, and an entire system may be made up of multiple computing devices 200, 250 communicating with each other.

Computing device 250 includes a processor 252, memory 264, an input/output device such as a display 254, a communication interface 266, and a transceiver 268, among other components. The device 250 may also be provided with a storage device, such as a microdrive or other device, to provide additional storage. Each of the components 250, 252, 264, 254, 266, and 268, are interconnected using various buses, and several of the components may be mounted on a common motherboard or in other manners as appropriate.

The processor 252 can execute instructions within the computing device 250, including instructions stored in the memory 264. The processor may be implemented as a chipset of chips that include separate and multiple analog and digital processors. Additionally, the processor may be implemented using any of a number of architectures. For example, the processor 210 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 250, such as control of user interfaces, applications run by device 250, and wireless communication by device 250.

Processor 252 may communicate with a user through control interface 258 and display interface 256 coupled to a display 254. The display 254 may be, for example, a TFT (Thin-Film-Transistor Liquid Crystal Display) display or an OLED (Organic Light Emitting Diode) display, or other appropriate display technology. The display interface 256 may comprise appropriate circuitry for driving the display 254 to present graphical and other information to a user. The control interface 258 may receive commands from a user and convert them for submission to the processor 252. In addition, an external interface 262 may be provided in communication with processor 252, so as to enable near area communication of device 250 with other devices. External interface 262 may provide, for example, for wired communication in some implementations, or for wireless communication in other implementations, and multiple interfaces may also be used.

The memory 264 stores information within the computing device 250. The memory 264 can be implemented as one or more of a computer-readable medium or media, a volatile memory unit or units, or a non-volatile memory unit or units. Expansion memory 274 may also be provided and connected to device 250 through expansion interface 272, which may include, for example, a SIMM (Single In Line Memory Module) card interface. Such expansion memory 274 may provide extra storage space for device 250, or may also store applications or other information for device 250. Specifically, expansion memory 274 may include instructions to carry out or supplement the processes described above, and may include secure information also. Thus, for example, expansion memory 274 may be provide as a security module for device 250, and may be programmed with instructions that permit secure use of device 250. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 264, expansion memory 274, or memory on processor 252 that may be received, for example, over transceiver 268 or external interface 262.

Device 250 may communicate wirelessly through communication interface 266, which may include digital signal processing circuitry where necessary. Communication interface 266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 268. In addition, short-range communication may occur, such as using a Bluetooth, WiFi, or other such transceiver (not shown). In addition, GPS (Global Positioning System) receiver module 270 may provide additional navigation- and location-related wireless data to device 250, which may be used as appropriate by applications running on device 250.

Device 250 may also communicate audibly using audio codec 260, which may receive spoken information from a user and convert it to usable digital information. Audio codec 260 may likewise generate audible sound for a user, such as through a speaker, e.g., in a handset of device 250. Such sound may include sound from voice telephone calls, may include recorded sound (e.g., voice messages, music files, etc.) and may also include sound generated by applications operating on device 250.

The computing device 250 may be implemented in a number of different forms, as shown in the figure. For example, it may be implemented as a cellular telephone 280. It may also be implemented as part of a smartphone 282, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A spatial tracking system comprising:
at least two mobile devices, each having wireless communications functionality, a display screen, and a user interface displayed on the display screen;
a server in communication with the at least two mobile devices, and programmed to continuously (i) receive position and orientation information from each of the mobile devices, (ii) to generate signal information unique to the at least two mobile devices; (iii) calculate distance information and direction information relative to the at least two mobile devices, and (iv) communicate the unique signal information, the distance information and the direction information to the at least two mobile devices;
wherein the at least two mobile devices are programmed to continuously (i) receive the unique signal information, the distance information, and the direction information from the server, and (ii) present the received unique signal information, distance information, and direction information on each of the at least two mobile devices; and
wherein the server and the at least two mobile devices are programmed to continue to perform their respective programmed functions until the at least two mobile devices converge to a common location.

2. A computer-implemented method comprising:
(a) receiving input from a first user device that identifies a second user device;
(b) sending a notification to the second user device, the notification notifying a second user associated with the second user device that a first user associated with the first user device desires to converge with the second user at a common location;
(c) receiving information from the first user device identifying a location and an orientation of the first user device;
(d) receiving information from the second user device identifying a location and an orientation of the second user device;
(e) calculating a direction and distance between the first user device and the second user device;
(f) generating signal information unique to the first and second user devices;
(g) communicating information to the first and second user devices, the communicated information such that the first and second user devices each presents the calculated distance between the user devices, a directional arrow vector pointing one device towards the other, and the unique signal information; and
(h) repeating (c), (d), (e), (f), and (g) until the first and second user devices have converged to a common location.
